(19) United States
(12) Patent Application Publication
(10) Pub. No.: US 2003/0110077 A1
(43) Pub. Date: Jun. 12, 2003

(54) Prize system using access counter

(76) Inventor: Uichiro Fujino, Tokyo (JP)

Correspondence Address: Lowe Hauptman Gopstein, Gilman & Berner, Suite 310, 1700 Diagonal Road, Alexandria, VA, 22314, US

(21) Appl. No.: 09/869,969

(22) PCT Filed: May 1, 2001
(86) PCT No.: PCT/JP01/03776

(30) Foreign Application Priority Data
Nov. 30, 2000 (JP) 2000-364898

(51) Int. Cl. G06F 17/60

(52) U.S. Cl. 705/14

(57) ABSTRACT

Many Internet web pages are provided with an access counter. However, access counters conventionally occupy precious space on the top page of a web site, even though they have just the single function of displaying the number of accesses. In the present invention, a counter numbers center 11 specifies a sponsor company 31 and holds a numbers game for predicting the number of an access counter provided on the sponsor's web page at a specified time and date. Participants 21, 22, and 23 access the sponsor company 31, view the access counter, predict a value for the counter at the specified date and time, and register this value with the counter numbers center 11. The counter numbers center 11 reads the count on the sponsor's web page at the given date and time and announces the count as the selection number.

### FIELD OF THE INVENTION

The present invention relates to a prize contest system employing an access counter. The access counter is provided on a web page presented by a sponsor business. The prize contest system determines numbers for selecting prize winners based on the count of the access counter at a predetermined time and date.

### BACKGROUND ART

Many Internet web pages are provided with an access counter for displaying the number of people that have visited the site (access count). Each time the web site is accessed, i5 an access counter program on the web server is executed. The program increments and updates its counter variable by one.

The value of the counter variable is transmitted with HTML data to the computer terminal accessing the web site. The accessing computer terminal displays a message, such as “You are the 7777^{th} visitor.”

This access counter enables the creator of the web page to learn the popularity of the website by the number of accesses and to verify whether the administrative policy of the web page meets the users' needs. The individual accessing this site can also determine to some extent the popularity of the web page based on the count of the access counter. This gives the user one method of determining whether or not to view the contents provided on the web page. Most web pages provide an access counter for this convenience.

As described above, most Internet web pages are provided with access counters. Furthermore, the access counters are usually provided in an obvious location on the top page. However, while the access counters possess the convenience of learning the popularity and reliability of a web site, they are generally used for the sole purpose of displaying the number of visitors (access number). Hence, access counters conventionally occupy precious space on the top page of a web site, even though they have just the single function of displaying the number of accesses.

In view of the foregoing, it is an object of the present invention to provide a prize contest system employing an access counter, which system more effectively uses the access counter.

### DISCLOSURE OF THE INVENTION

This object and others will be attained according to means detailed in the accompanying claims. According to claim 1, a prize contest system employs an access counter on an Internet web page for counting the number of visitors to the web page, wherein the web page is set as the object of the prize contest and a selection number is determined based on the count of the access counter at a predetermined date and time.

According to claim 2, a prize contest system employs an access counter on an Internet web page for counting the number of visitors to the web page, wherein the web page is set as the object of the prize contest and a selection number is determined based on one or more digits in the count of the access counter at a predetermined date and time.

According to claim 3, a prize contest system employs an access counter on an Internet web page for counting the number of visitors to the web page, wherein the web page is set as the object of the prize contest and a selection number is determined based on one or more low-order digits in the count of the access counter at a predetermined date and time.

According to claim 4, a prize contest system employs an access counter on an Internet web page for counting the number of visitors to the webpage, wherein the system comprises means for specifying the web page of a company sponsoring the contest; means for determining a selection number based on the count of the access counter on the specified web page at a predetermined date and time; and means for receiving records of participants in the contest and the selection number the participants have predicted.

According to claim 5, a prize contest system employs an access counter on an Internet web page for counting the number of visitors to the webpage, wherein the system comprises means for specifying the web page of a company sponsoring the contest; means for determining a selection number based on one or more digits in the count of the access counter on the specified web page at a predetermined date and time; and means for receiving records of participants in the contest and the selection number the participants have predicted.

According to claim 6, a prize contest system employs an access counter on an Internet web page for counting the number of visitors to the web page, wherein the system comprises means for specifying the web page of a company sponsoring the contest; means for determining a selection number based on one or more low-order digits in the count of the access counter on the specified web page at a predetermined date and time; and means for receiving records of participants in the contest and the selection number the participants have predicted.

According to claim 7, a prize contest system employs an access counter as recited in any of claims 4 through 6, wherein the company serving as the sponsor for the prize contest is changed after a prescribed entry-accepting period.

According to claim 8, the prize contest system employing an access counter as recited in any of claims 4 through 7 further comprises a counter numbers center for disclosing rules of the contest on the Internet and for recording predictions of the selection number received via the Internet from participants in the contest.

According to claim 9, the prize contest system employs an access counter as recited in claim 8, wherein monetary or material prizes are awarded to winners of the contest only when the winners step forward and claim their prize from the counter numbers center.

According to claim 10, a prize contest system employs an access counter as recited in either of claims 8 or 9, wherein a web server operated by the counter numbers center comprises means for disclosing rules of the contest on a web page; means for receiving predictions of the selection number via the Internet during the prescribed entry-accepting period; means for reading the count of the access counter on the web page operated by the sponsor at the predetermined time after the entry-accepting period and for determining the selection number based on the count; and means for announcing the selection number on the web page.

According to claim 11, a prize contest system employs an access counter as recited in any of claims 8 through 10, wherein a web server operated by the counter numbers center comprises means for disclosing rules of the contest on a web page; means for notifying via e-mail participants registered for an e-mail magazine regarding the rules of the contest; means for receiving predictions of the selection number via the Internet during the prescribed entry-accepting period; means for reading the count of the access counter on the web page operated by the sponsor at the predetermined time after the entry-accepting period and for determining the selection number based on the count; means for notifying via e-mail participants registered for the e-mail magazine of the selection number; means for announcing the selection number on the web page.

According to claim 12, a prize contest system employs an access counter as recited in any of claims 1 through 11, wherein the monetary or material prizes are carried over to the next prize contest when there are no winners or when the winners do not come forward to accept their prizes.

According to claim 13, a prize contest system employs an access counter as recited in any of claims 1 through 12, wherein the monetary or material prizes are divided among the winners when there is a plurality of winners.

The access counter here uses the common method of counting the visitors to a web page by incrementing the count value with each access. However, the counter can be represented by an array of numbers or characters or a graphic that changes with each access. Further, the value can be either incremented or decremented. Hence, there is no limitation to the access counter, providing it indicates a changing value or shape.

### BRIEF DESCRIPTION OF THE DRAWINGS

FIG. 1 is an explanatory diagram showing an example system configuration of the prize contest system employing an access counter according to the preferred embodiment;

FIG. 2 is a flowchart describing the operations of the system in FIG. 1; and

FIG. 3 is an explanatory diagram showing the operations according to a variation of the preferred embodiment.

### DETAILD DESCRIPTION OF THE INVENTION

A prize contest system employing an access counter according to preferred embodiments of the present invention will be described while referring to the accompanying drawings.

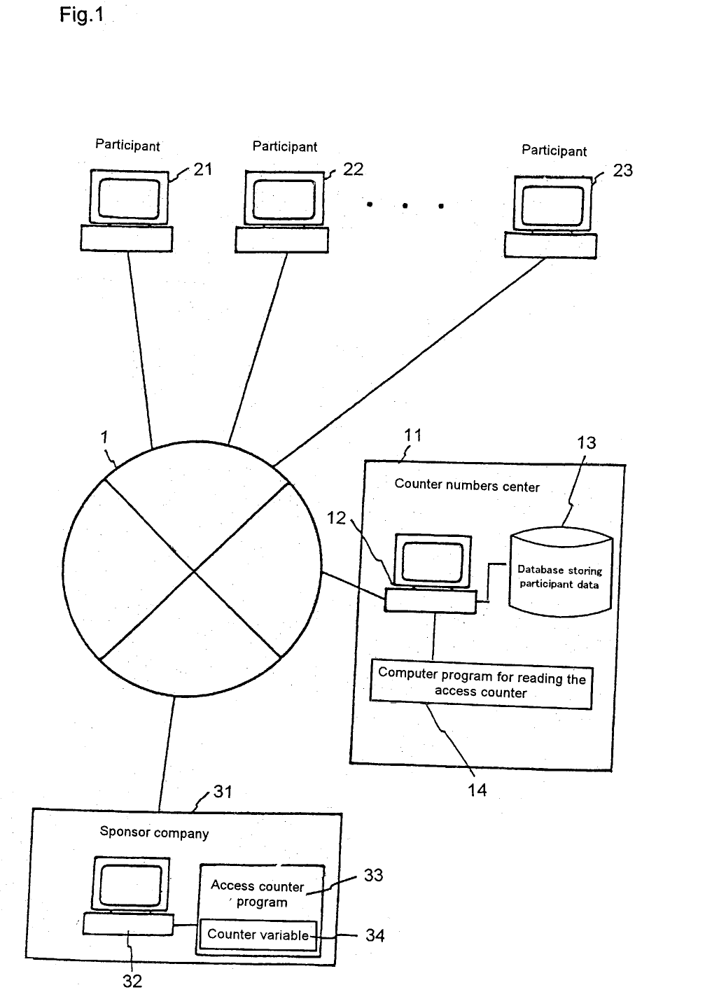

FIG. 1 is an explanatory diagram showing an example system configuration of the prize contest system employing an access counter according to the preferred embodiment. As shown in the diagram, the system includes an Internet 1, a counter numbers center 11 that sponsors a numbers game using an access counter, a web server 12 provided at the counter numbers center 11, a database 13 that registers participants in the numbers game and the counts predicted by the participants, a computer program 14 for reading the count of the access counter on the sponsor's site, computer terminals 21, 22, and 23 used by participants in the numbers game (hereinafter also referred to as the participants 21, 22, and 23), a sponsor company 31, a web server 32 at the sponsor company 31, an access counter program 33, and a counter variable 34.

In the system configuration shown in FIG. 1, the counter numbers center 11 sponsors a numbers game in which participants guess what the count of an access counter provided on a web page presented by the sponsor company 31 will be at a predetermined date and time. The counter numbers center 11 provides a web page describing details for implementing the numbers game and sends notifications to registered members via an e-mail magazine. The access counter program 33 installed in the web server 32 updates the counter variable 34 by incrementing the count one each time the web page is accessed.

The participants 21, 22, and 23 open the web page on the sponsor company 31 and view the access counter provided on that web page. Then they predict the count of the access counter for a time and date (drawing time) specified in a detailed description given on the web site provided by the counter numbers center 11. These count predictions are transmitted to the web server 12. The web server 12 records the predicted counts received from the participants 21, 22, and 23 in the database 13.

After a prescribed period for receiving predictions from participants ends and when the predetermined drawing time arrives, the web server 12 starts the computer program 14 for extracting the count. The computer program 14 reads and stores the count of the access counter on the web page provided by the database 13. This extracted count is the selection number of the numbers game.

The selection number is announced on the web page at the counter numbers center 11 and is distributed to members registered for the e-mail magazine. After the completion of one numbers game (after the period in which applications are accepted), a new numbers game is started using a different sponsor company.

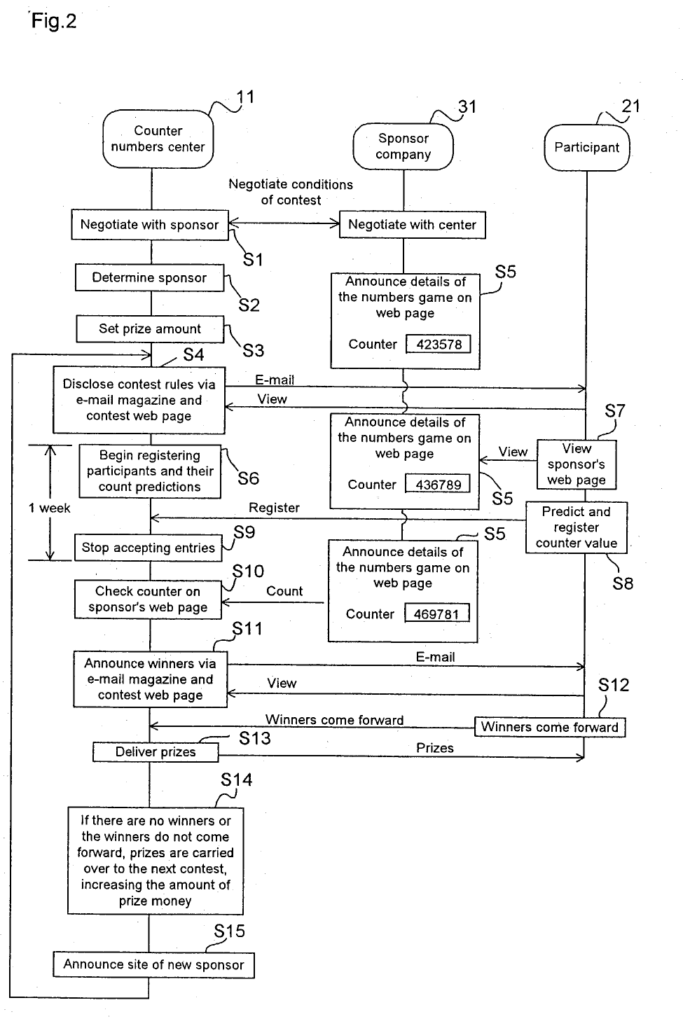

FIG. 2 is a flowchart describing the operations of the system in FIG. 1. Next, the operations of the system will be described based on this flowchart.

(1) First, the counter numbers center 11 conducts negotiations with a company for sponsoring the numbers game regarding conditions for implementing the game and sets the period for conducting the numbers game, the type of prize (monetary or material), the sponsor fee, and the like (steps S1, S2, and S3).

(2) The counter numbers center 11 contacts all members registered for the e-mail magazine by e-mail regarding the details of the coming numbers game, such as the contest rules and the application procedure. Further, the counter numbers center 11 displays details of the numbers game on its prize contest web page (step S4).

(3) At the same time, the company sponsoring the numbers game includes information on its web page at the sponsor company 31 explaining that the company will be holding a numbers game for predicting the count on its access counter and explaining the details thereof (step S5).

(4) The counter numbers center 11 begins to record participants in the numbers game and the counter values predicted thereby (step S6). In this example, the predictions are collected for a period of one week, and the targeted web page for the numbers game changes every week.

(5) The participants 21, 22, and 23 learn about the numbers game, including the contest rules and procedures of application after receiving the e-mail magazine via e-mail or after viewing the prize contest web page provided by the counter numbers center 11. Subsequently, the users view the web page provided by the sponsor company 31 (step S7).

(6) The participants view the value of the access counter on this web page, estimate how much the counter will be at the drawing time specified in the description of the contest rules, and register a prediction at the counter numbers center 11 (step S8).

(7) When one week has elapsed since the date on which entries were first accepted, the counter numbers center 11 quits accepting entries (step S9).

(8) On the predetermined drawing time after no longer accepting applications, the counter numbers center 11 extracts the count of the access counter at the sponsor company 31 (step S10). The extracted number is referred to as the selection number. In this example, the selection number is “469781.”

(9) All participants registered for the e-mail magazine are notified of the selection number by e-mail. Further, the selection number is announced on the prize contest web page presented by the counter numbers center 11 (step S11).

(10) The participants 21, 22, and 23 determine whether their estimations of the count were correct by viewing an article announcing the selection number on the prize contest web page or by referring to the e-mail magazine. In the case that a participant has won, that participant notifies the counter numbers center 11 (step S12).

(11) If winners come forward to claim the prize, the counter numbers center 11 divides up the prize based on the number of winners and delivers the prizes to the winners (step S13).

(12) If there are no winners or if the winners do not come forward, the prizes are carried over to the next game (step S14).

(13) Subsequently, the counter numbers center 11 announces the site of the next sponsor, and the next numbers game begins (step S15).

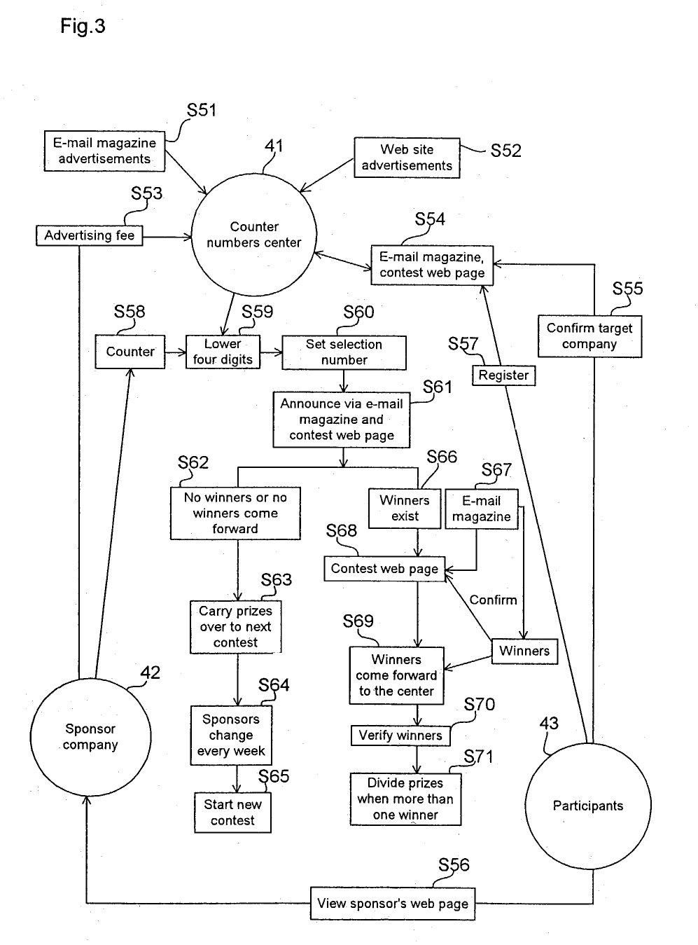

FIG. 3 is an explanatory diagram showing the operations according to a variation of the preferred embodiment.

As shown in the diagram, the system includes a counter numbers center 41, a sponsor company 42, participants in the numbers game 43, and winners of the numbers game 44. In the numbers game of this example, participants predict the value of the last four digits in the access counter provided on a web site maintained by the sponsor company 42.

Next, the operations of the system will be described.

(1) For revenue, the counter numbers center 41 administers advertising fees for advertising in its e-mail magazine (step S51), advertising fees for placing banner ads on its website (step S52), and advertising fees from the company sponsoring the numbers game (step S53).

(2) The counter numbers center 41 announces the sponsor company 42 via the e-mail magazine and the prize contest web page as the targeted site of the numbers game (step S54).

(3) The participants 43 check the site targeted for the next numbers game in the e-mail magazine or on the prize contest web page (step S55).

(4) The participants 43 view the web page provided by the sponsor company 42. After checking the count of the access counter on that web page, the participants 43 estimate the count on the counter at the specified drawing date and time (step S56).

(5) The participants 43 record their estimated count at the counter numbers center 41 via the prize contest web site provided by the counter numbers center 41.

(6) The counter numbers center 41 reads the value of the access counter on the web page of the sponsor company 42 on the day and time specified in the details of the game and after the period for collecting entries and sets the selection number to the last four digits of this value (steps S58, S59, and S60).

(7) Participants registered for the e-mail magazine are notified of the selection number via e-mail, and the selection number is announced on the prize contest web site (step 61).

(8) When there are winners, the winners 44 verify that their predicted count is the selection number via the e-mail magazine or the prize contest web site (steps S66, S67, and S68).

(9) The winners 44 notify the counter numbers center 41 that they are winners (step S69).

(10) The counter numbers center 41 verifies the authenticity of the winners 44 (step S70).

(11) The counter numbers center 41 divides the prize money or material awards when there is a plurality of winners 44 and delivers the prizes to the winners 44 (step S71).

(12) If there are no winners or if the winners do not come forward, the prizes are carried over to the next game (step S63).

(13) Every week the sponsor company is changed and the next numbers game is started (steps S64 and S65).

In the examples described above, the winners of the numbers game must come forward themselves to receive their prizes. However, it is obvious that the counter numbers center 11 can also send the prizes to the winners after notifying them of their selection.

Further, the selection number in the examples described above is the value of the access counter or the last four digits in the access counter. However, various methods can be employed, including an arbitrary combination of digits in the access counter, the upper four digits in the access counter, the sum of all digits in the access counter, and the like.

While the prize contest system employing an access counter has been described in detail with reference to specific embodiments thereof, it would be apparent to those skilled in the art that many modifications and variations may be made therein without departing from the spirit of the invention.

### INDUSTRIAL APPLICABILITY

As described above, the prize contest system employing an access counter of the present invention receives predictions of the count on an access counter that is provided on a web page presented by a selected company and awards monetary or material prizes to the participants who guess correctly. Accordingly, the access counter is used more effectively than simply a function for counting visitors.

Further, participants in the numbers game become interest in the state of the access counter and access the web page of the sponsor frequently, thereby increasing the effectiveness of advertisements on the sponsors web page.

Further, while there are an unspecified number of people other than participants in the numbers game that will access the web site, it is expected that participants in the contest can to some degree control the count with their own accesses, increasing the competitive attraction of the contest, as well as the number of accesses to the web page. Since the prizes are carried over to the next game in the event that there are no winners, the amount of the prize may grow very large. Increased prize money will arouse the passion of the participants, further increasing the number accesses to the web site and increasing the effect of advertising on the site.

What is claimed is:

1. A prize contest system employing an access counter on an Internet web page for counting the number of visitors to the web page, wherein the web page is set as the object of the prize contest and a selection number is determined based on the count of the access counter at a predetermined date and time.

2. A prize contest system employing an access counter on an Internet web page for counting the number of visitors to the web page, wherein the web page is set as the object of the prize contest and a selection number is determined based on one or more digits in the count of the access counter at a predetermined date and time.

3. A prize contest system employing an access counter on an Internet web page for counting the number of visitors to the web page, wherein the web page is set as the object of the prize contest and a selection number is determined based on one or more low-order digits in the count of the access counter at a predetermined date and time.

4. A prize contest system employing an access counter on an Internet web page for counting the number of visitors to the web page, the system comprising:
means for specifying the web page of a company sponsoring the contest;
means for determining a selection number based on the count of the access counter on the specified web page at a predetermined date and time; and
means for receiving records of participants in the contest and the selection number the participants have predicted.

5. A prize contest system employing an access counter on an Internet web page for counting the number of visitors to the web page, the system comprising:
means for specifying the web page of a company sponsoring the contest;
means for determining a selection number based on one or more digits in the count of the access counter on the specified web page at a predetermined date and time; and
means for receiving records of participants in the contest and the selection number the participants have predicted.

6. A prize contest system employing an access counter on an Internet web page for counting the number of visitors to the web page, the system comprising:
means for specifying the webpage of a company sponsoring the contest;
means for determining a selection number based on one or more low-order digits in the count of the access counter on the specified web page at a predetermined date and time; and
means for receiving records of participants in the contest and the selection number the participants have predicted.

7. A prize contest system employing an access counter as recited in any of claims 4 through 6, wherein the company serving as the sponsor for the prize contest is changed after a prescribed entry-accepting period.

8. A prize contest system employing an access counter as recited in any of claims 4 through 7, further comprising a counter numbers center for disclosing rules of the contest on the Internet and for recording predictions of the selection number received via the Internet from participants in the contest.

9. A prize contest system employing an access counter as recited in claim 8, wherein monetary or material prizes are awarded to winners of the contest only when the winners step forward and claim their prize from the counter numbers center.

10. A prize contest system employing an access counter as recited in either of claims 8 or 9, wherein a web server operated by the counter numbers center comprises:
means for disclosing rules of the contest on a web page;
means for receiving predictions of the selection number via the Internet during the prescribed entry-accepting period;
means for reading the count of the access counter on the web page operated by the sponsor at the predetermined time after the entry-accepting period and for determining the selection number based on the count; and
means for announcing the selection number on the web page.

11. A prize contest system employing an access counter as recited in any of claims 8 through 10, wherein a web server operated by the counter numbers center comprises:
means for disclosing rules of the contest on a web page;
means for notifying via e-mail participants registered for an e-mail magazine regarding the rules of the contest;
means for receiving predictions of the selection number via the Internet during the prescribed entry-accepting period;
means for reading the count of the access counter on the web page operated by the sponsor at the predetermined time after the entry-accepting period and for determining the selection number based on the count;
means for notifying via e-mail participants registered for the e-mail magazine of the selection number;
means for announcing the selection number on the web page.

12. A prize contest system employing an access counter as recited in any of claims 1 through 11, wherein the monetary or material prizes are carried over to the next prize contest when there are no winners or when the winners do not come forward to accept their prizes.

13. A prize contest system employing an access counter as recited in any of claims 1 through 12, wherein the monetary or material prizes are divided among the winners when there is a plurality of winners.
